(19) United States
(12) Patent Application Publication
(10) Pub. No.: US 2013/0298676 A1
(43) Pub. Date: Nov. 14, 2013

(54) MEASURING DEVICE AND MEASURING METHOD

(71) Applicant: Testo AG, Lenzkirch (DE)

(72) Inventor: Christoph Bauer, Clausthal-Zellerfeld (DE)

(21) Appl. No.: 13/868,210

(22) Filed: Apr. 23, 2013

(30) Foreign Application Priority Data
Apr. 25, 2012 (DE) 102012008102.2

(51) Int. Cl. G01N 21/17

(52) U.S. Cl. CPC G01N 21/1702
USPC 73/584

(57) ABSTRACT

In a measurement device (1) including a measurement chamber (2), in which an electromagnetic wave (4), having a carrier frequency and modulated by a modulation frequency, acts on a sample, it is proposed to arrange an acoustic pickup (6), which is tuned to the modulation frequency, outside of the measurement chamber (2) and to connect this acoustic pickup via acoustic decoupling means (9) to the measurement chamber (2) for detecting acoustic excitations (5) generated in the sample by the acting electromagnetic wave (4).

### BACKGROUND

The invention relates to a measurement device for examining at least one constituent in a solid, liquid or gaseous sample, comprising a measurement chamber for receiving the sample, a light source, which is configured to generate an electromagnetic wave, interacting with the sample in the measurement chamber, having a carrier frequency and a modulation frequency, wherein the carrier frequency is tuned to the at least one constituent, and comprising an acoustic pickup, which is tuned to the modulation frequency.

The invention furthermore relates to a measurement method for examining at least one constituent in a solid, liquid or gaseous sample, wherein the sample is passed into a measurement chamber, a light source is used to generate an electromagnetic wave having a carrier frequency and a modulation frequency and radiate it onto the sample in the measurement chamber, the carrier frequency being tuned to the at least one constituent, and an acoustic pickup, which is tuned to the modulation frequency, is used to detect an interaction of the electromagnetic wave with the at least one constituent of the sample.

U.S. Pat. No. 7,245,380 B2 discloses a measurement device and a measurement method, in which a tuning fork is arranged in the interior of a measurement cell and, in contrast to conventional photoacoustic spectroscopy, the absorbed energy is accumulated in a tuning fork rather than the absorbed energy being accumulated in the measurement chamber.

### SUMMARY

The underlying object of the invention is to develop a measurement device which has robust usage properties for frequent use.

In order to achieve this object, provision is made according to the invention in a measurement device of the type described at the outset for the acoustic pickup to be arranged outside of the measurement chamber and for, on or in a wall of the measurement chamber, acoustic decoupling means to be formed, by means of which the acoustic pickup is or can be coupled acoustically to the sample situated in the measurement chamber. Hence, a transmission of acoustic excitations, e.g. sound waves, from the sample to the acoustic pickup is made possible by the acoustic decoupling means. Here, it is advantageous that direct contact between the acoustic pickup and the sample can be avoided. Hence, the acoustic pickup cannot become dirty as easily. The measurement device designed according to the invention therefore remains ready for use for a larger number of measurement processes, without complicated servicing or replacement of individual parts being required. It is furthermore advantageous that damage, wear-and-tear and/or aging of sensitive parts of the acoustic pickup due to the sample can be avoided or at least reduced. Hence, the usage properties of the measurement device according to the invention can be configured to be so robust that the measurement device can be designed suitable for continuous use. It is particularly expedient for the sample to be gaseous or liquid.

The electromagnetic wave can be modulated by the modulation frequency, for example as a result of amplitude modulation, more particularly by pulsing, or as a result of frequency modulation. The modulation preferably extends over at least one wavelength of the carrier frequency.

In one embodiment of the invention, provision can be made for the acoustic pickup to comprise a resonator, which is connected to the acoustic decoupling means. Here, it is advantageous that this allows an acoustic excitation, which is transmitted by the acoustic decoupling means, to be amplified. Hence the sensitivity of the acoustic pickup can be increased once again. The resonator is preferably designed as a cavity resonator. It is particularly expedient if the resonator is embodied as a microresonator.

In one embodiment of the invention, provision can be made for the acoustic decoupling means to be embodied as an acoustic window. An acoustic window is wholly or partly transmissive to acoustic excitations. Here, the window can be designed to be wholly or partly impermeable to the sample. Here, it is advantageous that it is possible to form acoustic decoupling means by which an ingress or diffusion of the sample into the acoustic pickup can be wholly or at least partly avoided.

Here, provision can be made for the acoustic decoupling means to comprise an acoustic separation element, which is transmissive to an acoustic excitation which is to be detected with or detectable by the acoustic pickup. Provision is preferably made here for the acoustic separation element to be configured to be gas-tight and/or liquid-tight. By way of example, the acoustic separation element can be formed as a membrane or as a preferably fine mesh screen. Here, it is advantageous that a transmission of the acoustic excitation, which can be generated by the electromagnetic wave radiated into the measurement chamber, can be transmitted to the acoustic pickup with sufficient detection sensitivity. A diffusion of the sample into the acoustic pickup can be prevented by the separation element if the mesh of the screen has fine enough dimensions.

In one embodiment of the invention, provision can be made for the acoustic pickup to comprise a resonance element responding to acoustic excitations, which resonance element is tuned to the modulation frequency. By way of example, the resonance element can be formed as a tuning fork. It is particularly expedient if the resonance element is formed as a micro-tuning-fork. Here, it is advantageous that an acoustic excitation, which is caused by an interaction at the constituents in the sample as a result of the optical excitation, namely the electromagnetic wave, radiated thereon can be detected with very good measurement sensitivity in the acoustic pickup. The resonance element is preferably arranged in the resonator.

In one embodiment of the invention, provision can be made for the light source or optical source to be arranged outside of the measurement chamber and to be coupled or to be able to be coupled to the sample situated in the measurement chamber via optical coupling means formed in or on the or a further wall of the measurement chamber. Here, it is advantageous that direct contact of sensitive parts of the light source with the sample can be avoided. Hence, dirtying or wear-and-tear of the light source due to the sample can be avoided, which can once again increase the stability of the measurement device.

In one embodiment of the invention, provision can be made for the optical coupling means to be embodied as an optical window. Hence, the optical coupling means for the generated or generable electromagnetic waves being embodied in a transmissive fashion can be achieved in a simple manner.

Here, provision can be made for the optical coupling means to comprise an optical separation element which is configured to be transmissive to the electromagnetic waves which are generated by the light source. The optical separation element preferably has a gas-tight and/or liquid-tight design in order to prevent diffusion or ingress of the sample into the light source. By way of example, the optical separation element can be formed as a pane or a membrane, which is respectively configured to be transparent or transmissive to electromagnetic waves at the carrier frequency.

In one embodiment of the invention, provision can be made for the measurement chamber to be designed such that the liquid or gaseous sample continuously flows therethrough. Here, it is advantageous that continuous measurements can be carried out in a simple manner.

By way of example, a laser or an LED can be used as a light source. It is particularly expedient if cost-effective and robust LEDs are configured and used for generating the electromagnetic wave.

In one embodiment of the invention, provision can be made for the acoustic pickup to be designed such that it can be heated. It is preferable for the resonance element of the acoustic pickup to be designed such that it can be heated. Here, it is advantageous that defined measurement properties of the acoustic pickup can be achieved. It is furthermore advantageous that corrosion or a similar material change on the acoustic pickup and/or deposits on the acoustic pickup can be prevented. Hence, a resonant frequency of the resonance element can be set constant in time. As a result of the arrangement according to the invention of the acoustic pickup outside of the measurement chamber, it is moreover possible to achieve that there is no impairment of or change in the sample as a result of heating the acoustic pickup.

In order to achieve the aforementioned object, provision is made according to the invention in the case of a measurement method of the type described at the outset for an acoustic excitation, generated by the interaction of the electromagnetic wave with the constituent, to be decoupled via acoustic decoupling means, formed in or on a wall of the measurement chamber, and for the decoupled acoustic excitation to be detected by the acoustic pickup outside of the measurement chamber. Here, it is advantageous that it is possible to set up a separation or a barrier between the sensitive acoustic pickup and the possibly aggressive sample in the measurement chamber. Hence, the stability, i.e. the interval between necessary services, can be increased in a measurement device used when carrying out the measurement method according to the invention.

In one embodiment of the invention, provision can be made for the decoupled acoustic excitation to be amplified outside of the measurement chamber in a resonator connected to the acoustic decoupling means. Here, it is advantageous that the detection sensitivity of the acoustic pickup can be increased. Hence, it is possible to compensate for signal losses in particular, which emerge at the acoustic decoupling means. The signal-to-noise ratio can therefore be improved.

In one embodiment of the invention, provision can be made for the decoupled acoustic excitation to be used to excite a resonance of a resonance element in the acoustic pickup. Here, it is advantageous that the detection can be directed specifically at the modulation frequency. Hence the acoustic pickup can be used selectively on acoustic excitations generated at the constituent by the electromagnetic wave. Interfering influences from other sources can therefore be masked, since these often lie at other frequencies.

In one embodiment of the invention, provision can be made for the electromagnetic wave to be generated outside of the measurement chamber. Here, it is advantageous that the measurement chamber can be formed very small and robustly, since a light source for generating the electromagnetic wave requires no additional installation space in the measurement chamber. It is furthermore advantageous that the generation of the electromagnetic wave, for example by means of a laser, can be carried out without interference by the sample.

In one embodiment of the invention, provision can be made for the generated electromagnetic wave to be coupled into the sample situated in the measurement chamber via optical coupling means formed in or on the or a further wall of the measurement chamber. Here, it is advantageous that it is possible to set up a barrier between the sample and a sensitive light source, for example an LED or a laser. Hence, dirtying or wear-and-tear of the light source and of its optical units as a result of contact with the sample can be avoided.

In one embodiment of the invention, provision can be made for the sample to flow through the measurement chamber in a continuous flow. Here, it is advantageous that continuous measurements or frequently repeated individual measurements can be carried out easily. This is particularly expedient in the case of liquid or gaseous samples.

In one embodiment of the invention, provision can be made for the acoustic pickup to be heated. Here, it is advantageous that aging processes in the acoustic pickup can be delayed. It is particularly expedient if the resonance element of the acoustic pickup is heated. Here, it is advantageous that a temperature-dependent change of resonant frequencies of the resonance element can be prevented by virtue of the resonance element being kept at a constant operating temperature as a result of the heating.

Particularly expedient usage properties emerge if the measurement method according to the invention is used in a measurement device according to the invention. Here, it is advantageous that the components of the measurement device according to the invention allow simple implementation of the features of the measurement method according to the invention.

The invention will now be described in more detail on the basis of an exemplary embodiment; however, it is not restricted to this exemplary embodiment. Further exemplary embodiments emerge from combination of individual or several features of the patent claims with one another and/or with individual or several features of the exemplary embodiment.

### BRIEF DESCRIPTION OF THE DRAWING

The only FIGURE is as follows:

FIG. 1 shows a much simplified illustration of the principle of a measurement device according to the invention, for explaining the measurement method according to the invention.

### DETAILED DESCRIPTION OF THE PREFERRED EMBODIMENT

A measurement device, denoted by 1 in its entirety, comprises a measurement chamber 2. The measurement chamber 2 is configured for receiving a solid, liquid, or gaseous sample. Provision is preferably made for receiving liquid or gaseous samples.

The measurement device 1 furthermore comprises a light source 3, by means of which an electromagnetic wave 4 can be generated.

Here, the electromagnetic wave 4 is generated in such a way that it has a constant carrier frequency and a likewise constant modulation frequency. Here, the electromagnetic wave 4 can be amplitude-modulated by the modulation frequency.

By way of example, the electromagnetic wave can be light in a visible spectral range or near the visible spectral range. By way of example, the light source 3 can be embodied as an LED.

Here, the electromagnetic wave 4 can be light with a wavelength corresponding to the carrier frequency, wherein the light is pulsed with the modulation frequency.

The light source 3 is configured and arranged in such a way that the generated electromagnetic wave 4 is radiated into the measurement chamber 2.

There is an interaction between the electromagnetic wave 4 and the solid, liquid or gaseous sample in the measurement chamber 2. Here the carrier frequency of the electromagnetic wave 4 is tuned to a constituent to be examined in the sample by virtue of the carrier frequency being selected to equal an absorption frequency of the constituent.

As a result of the already mentioned modulation by the modulation frequency, an acoustic excitation 5—typically a sound wave—is therefore generated at the constituent, which acoustic excitation is detected by an acoustic pickup 6.

The frequency of the acoustic excitation 5 equals the modulation frequency or an integer multiple or an integer fraction of the modulation frequency of the electromagnetic wave 4.

The acoustic pickup 6 is tuned to the modulation frequency in order to detect the acoustic excitation 5.

The measurement device 1 is therefore designed to examine at least one constituent of the liquid or gaseous sample situated in the measurement chamber 2. Here, an output signal of the acoustic pickup 6 is evaluated in an evaluation unit 7, not illustrated in any more detail, which is configured in a manner known per se. By way of example, the evaluation unit 7 can be configured by lock-in amplifiers.

The measurement chamber 2 has a wall 8, in or on which acoustic decoupling means 9 are formed.

The acoustic pickup 6 is arranged outside of the measurement chamber 2 and connected to the acoustic decoupling means 9 in such a way that the acoustic excitation 5, generated by the interaction between the constituent of the sample and the electromagnetic wave 4 radiated thereon, is decoupled from the measurement chamber 2 via the acoustic decoupling means 9 and transmitted to the acoustic pickup 6.

The acoustic pickup 6 comprises a resonator 10 in the form of a cavity resonator, by means of which the decoupled acoustic excitation 5 is amplified. The resonator 10 is a microresonator. The resonator 10 and the acoustic decoupling means 9 therefore form a miniaturized acoustic channel of the acoustic pickup 6.

As a result of the geometric dimensions thereof, the resonator 10 is formed with a resonant frequency which is tuned to the modulation frequency of the electromagnetic wave 4 and hence to the frequency of the acoustic excitation 5.

The acoustic decoupling means 9 are embodied as acoustic window and are impermeable to the sample but at least partly transmissive to the acoustic excitation 5.

Here, the acoustic decoupling means 6 comprise an acoustic separation element 11, which is inserted into the aforementioned acoustic window in the style of a pane. In the exemplary embodiment, the acoustic separation element 11 is embodied as a membrane, which is transmissive to the acoustic excitations 5—in general for sound waves—but impermeable to gases and liquids. In further exemplary embodiments, the separation element 11 is embodied as a screen, which is inserted into the aforementioned window and impedes or even prevents diffusion of the sample into the acoustic pickup 6. To this end, the acoustic separation element 11 is formed in this case as a sufficiently fine-meshed screen.

The acoustic pickup 6 has a resonance element 12, which responds to the acoustic excitation 5. Hence, the resonance element 12—here according to the functional principle of a tuning fork—can be used to record the acoustic excitation 5 and convert it into an electric output signal. The resonance element 12 is arranged in the resonator 10 and/or between two half-shells 17, 18 of the resonator 10. The resonance element 12 is embodied as micro-tuning-fork.

The resonator 10 and the resonance element 12 therefore form a miniaturized acoustic pickup 6.

The evaluation unit 7 evaluates this electric output signal in order to derive statements in respect of the presence and/or in respect of properties—e.g. a concentration—of the constituent in the sample.

The resonance element 12 is tuned to the already mentioned modulation frequency by virtue of a resonant frequency of the resonance element 12 being selected to equal the modulation frequency or to be an integer multiple or an integer fraction of the modulation frequency.

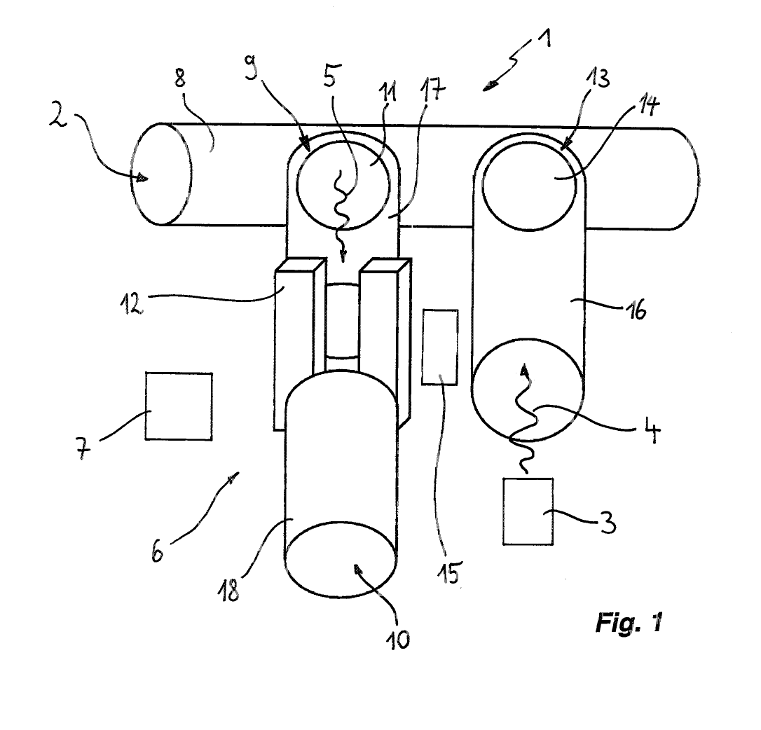

FIG. 1 furthermore shows that the light source 3 is likewise arranged outside of the measurement chamber 2.

Optical coupling means 13 as an optical window are formed in the wall 8 of the measurement chamber 2, into which optical coupling means an optical separation element 14 in the style of a pane is inserted.

The optical separation element 14 is transmissive to the electromagnetic waves 4 and embodied in the gas-tight or fluid-tight manner.

In the exemplary embodiment, the optical separation element 14 is embodied as a transparent membrane or as a transparent pane.

The light source 3 can therefore be coupled to the sample in the measurement chamber 2 via the optical coupling means 13.

During the operation of the measurement device 1, i.e. when carrying out the measurement method according to the invention, the electromagnetic wave 4 generated by the light source 3 is therefore generated outside of the measurement chamber 2 and coupled with the sample situated in the measurement chamber 2 via the optical coupling means 13.

This electromagnetic wave 4 radiated thereon is—provided the carrier frequency corresponds to an absorption frequency—absorbed by the constituents to be examined in the solid, liquid or gaseous sample in the measurement chamber 2. The modulation of the electromagnetic wave 4 brings about a local pressure change, which results in an acoustic excitation 5.

This acoustic excitation 5 is—as already described above—decoupled and detected by the resonance element 12 of the acoustic pickup 6.

The measurement chamber 2 is formed as part of a duct through which the sample to be examined flows in a continuous flow.

Finally, the measurement device 1 has a heating apparatus 15, which is only illustrated schematically and by means of which the resonance element 12 and hence the acoustic pickup 6 can be heated. Here, the heating apparatus 15 is actuated in such a way that the resonance element 12 and/or the interior of the resonator 10 is kept at a constant operating temperature, which may lie above the surrounding temperature or even above an evaporation temperature, e.g. of water.

The optical coupling means 13 are part of an optical channel 16, in which the electromagnetic wave 4 can be and is supplied to the sample.

Here, the sample can, in the measurement chamber 2, take the energy transported by the electromagnetic wave 4 if the carrier frequency of the electromagnetic wave 4 is set corresponding to constituents of the sample. As a result of the additionally provided modulation of the electromagnetic wave 4 by a modulation frequency, there is a periodic excitation of the sample or of at least the involved constituents of the sample, which leads to a change in pressure.

This change in pressure is decoupled as an acoustic excitation 5 via the acoustic pickup 6 forming an acoustic channel, as a result of which the resonance element 12 is excited to vibrate. By way of example, the amplitude of an output signal of the resonance element 12 can be measured as a measurement result. If need be, this can additionally be brought about in a time-resolved fashion by means of a measurement interval.

The aforementioned constituents of the sample can be particulate constituents. By way of example, these can be biological and/or organic constituents of the sample, for example bacteria and/or spores, or any other particulate constituents, for example dust and/or soot particles, or similarly extended objects. The use of particulate constituents is advantageous in that the optical excitation from the electromagnetic wave 4 radiated thereon can very efficiently be converted into a detectable acoustic excitation 5 by virtue of the particulate constituents being excited to vibrate.

In the measurement device 1 comprising a measurement chamber 2, in which an electromagnetic wave 4, having a carrier frequency and modulated by a modulation frequency, acts on a sample, it is proposed to arrange an acoustic pickup 6, which is tuned to the modulation frequency, outside of the measurement chamber 2 and to connect said acoustic pickup via acoustic decoupling means 7 to the measurement chamber 2 for detecting acoustic excitations 5 generated in the sample by the acting electromagnetic wave 4.

1. A measurement device (1) for examining at least one constituent in a solid, liquid or gaseous sample, comprising a measurement chamber (2) for receiving the sample, a light source (3) configured to generate an electromagnetic wave (4), interacting with the sample in the measurement chamber (2), having a carrier frequency and a modulation frequency, the carrier frequency is tuned to the at least one constituent, and an acoustic pickup (6), which is tuned to the modulation frequency, wherein the acoustic pickup (6) is arranged outside of the measurement chamber (2) and, in or on a wall (8) of the measurement chamber (2), an acoustic decoupling element (9) is provided by which the acoustic pickup (6) is coupled acoustically to the sample situated in the measurement chamber (2).

2. The measurement device (1) as claimed in claim 1, wherein the acoustic pickup (6) comprises a resonator (10), which is connected to the acoustic decoupling element (9).

3. The measurement device (1) as claimed in claim 1, wherein the acoustic decoupling element (9) comprises at least one of an acoustic window or a gas-tight or liquid-tight, acoustic separation element (11) which is transmissive to an acoustic excitation (5) which is to be detected with or detectable by the acoustic pickup (6).

4. The measurement device as claimed in claim 1, wherein the acoustic pickup (6) comprises a resonance element (12), responding to acoustic excitations (5), and said resonance element is tuned to the modulation frequency.

5. The measurement device (1) as claimed in claim 1, wherein the light source (3) is arranged outside of the measurement chamber (2) and is coupled or is able to be coupled to the sample situated in the measurement chamber (2) via an optical coupling element (13) formed in or on the or a further wall (8) of the measurement chamber (2).

6. The measurement device (1) as claimed in claim 6, wherein the optical coupling element (13) comprises as least one of an optical window or a gas-tight or liquid-tight, optical separation element (14) which is configured to be transmissive to the electromagnetic waves (4) generated by the light source (3).

7. The measurement device (1) as claimed in claim 1, wherein the measurement chamber (2) is designed such that the liquid or gaseous sample continuously flows therethrough.

8. A measurement method for examining at least one constituent in a solid, liquid or gaseous sample, comprising: passing the sample into a measurement chamber (2), using a light source (3) to generate an electromagnetic wave (4) having a carrier frequency and a modulation frequency and radiating the electromagnetic wave onto the sample in the measurement chamber (2), the carrier frequency being tuned to the at least one constituent, and using an acoustic pickup (6), which is tuned to the modulation frequency, to detect an interaction of the electromagnetic wave (4) with the at least one constituent of the sample, an acoustic excitation (5), generated by the interaction of the electromagnetic wave (4) with the constituent, is decoupled via acoustic decoupling element (9), on a wall (8) of the measurement chamber (2), and detecting the decoupled acoustic excitation (5) by the acoustic pickup (6) outside of the measurement chamber (2).

9. The measurement method as claimed in claim 8, further comprising amplifying the decoupled acoustic excitation (5) outside of the measurement chamber (2) in a resonator (10) connected to the acoustic decoupling element (9) or using the decoupled acoustic excitation (5) to excite a resonance of a resonance element (12) in the acoustic pickup (6).

10. The measurement method as claimed in claim 8, further comprising generating the electromagnetic wave (4) is outside of the measurement chamber (2) or coupling the generated electromagnetic wave (4) onto the sample situated in the measurement chamber (2) via an optical coupling element (13) on the further wall (8) of the measurement chamber (2).

11. The measurement method as claimed in claim 8, wherein the sample flows through the measurement chamber (2) in a continuous flow.

12. (canceled)

13. The measurement device (1) as claimed in claim 1, wherein the acoustic pickup (6) is heated.

14. The measurement method as claimed in claim 8, where the acoustic pickup (6) is heated.
